(19) United States
(12) Patent Application Publication
(10) Pub. No.: US 2011/0225823 A1
(43) Pub. Date: Sep. 22, 2011

(54) Cobalt alloy and method for its manufacture

(75) Inventor: Jozef H.G. Mattheij, Melick (NL)

(73) Assignee: Sulzer Turbo Services Venlo B.V., Lomm (NL)

(21) Appl. No.: 13/051,205

(22) Filed: Mar. 18, 2011

(30) Foreign Application Priority Data
Mar. 19, 2010 (EP) 10 157 037.2

(51) Int. Cl. B23P 6/00; B23K 26/00; C22C 30/00

(52) U.S. Cl. 29/889.1; 219/121.64; 420/588

(57) ABSTRACT

A cobalt alloy is proposed, made up of at least 30% by weight cobalt, 0 to 20% by weight nickel, 5 to 30% by weight chromium, 0.4 to 2.5% by weight carbon and at least one carbide-forming metal which forms carbides with the carbon, wherein the atomic ratio in the alloy of the carbide-forming metal to the carbon amounts to at least 0.8, wherein the alloy can furthermore optionally contain one or more of the elements molybdenum, tungsten, aluminum, titanium, niobium, iron, silicon, manganese, vanadium, boron, zirconium and contaminants. The carbides are present in the alloy in the form of a finely dispersed phase without a preferred direction.

The invention relates to a cobalt alloy in accordance with the preamble of the independent claim of this category and to a method for manufacturing such a cobalt alloy.

Cobalt alloys or cobalt-base alloys, which usually belong to the so-called super alloys, are frequently used today for high-temperature applications and in particular in corrosive environments. They are characterized by a high (temperature) strength and additionally provide high creep resistance as well as good resistance to seizing, abrasion and friction wear in general.

Cobalt-base alloys are in particular also used for parts of gas turbines which may typically be exposed to temperatures of up to more than 1000° C. in operation under highly oxidizing conditions. Turbine vanes represent one example, in particular those which are located in the hottest region of the turbine. It is known here to use cobalt alloys as welding material or coating material both for manufacturing turbine vanes, but also for repairing turbine vanes.

Known cobalt-base alloys typically contain the following components: Nickel is frequently added, in addition to the base element or compensating element cobalt, to stabilize the austenitic structure. The structure is meant by this which corresponds to the face centered cubic (fcc) structure of the austenite. Chromium is furthermore added, in particular to improve the corrosion resistance. It is also known to mix carbon into the alloy which serves to form carbides which increase the strength, the hardness and the wear resistance. In addition to chromium, other metals such as tungsten, tantalum, hafnium, molybdenum or zirconium are also added for the forming of carbides.

A directionally solidified cobalt-base alloy is known from U.S. Pat. No. 4,058,415, for example, in which tantalum carbides are separated in a fibrous structure. The tantalum carbides are embedded in the cobalt matrix as an aligned fibrous phase, that is the individual tantalum carbides are each formed as an elongate fiber, with these fibers being aligned substantially parallel to one another along a preferred direction.

Even if cobalt-base alloys with carbides have proved themselves in a number of respects, it has nevertheless been shown that many of the carbides are not stable, break down and are separated or deposited at grain boundaries, in particular at high temperatures. A reduced creep resistance results from this and the alloy becomes more prone to cracking, in particular at the grain boundaries.

Starting from this prior art, it is therefore an object of the invention to propose a cobalt alloy which does not have this disadvantage and permanently has very good mechanical properties, in particular at high temperatures. Furthermore, a method for manufacturing such a cobalt alloy will be proposed.

The subject matters of the invention satisfying these objects are characterized by the features of the independent claims.

In accordance with the invention, a cobalt alloy is therefore proposed, made up of at least 30% by weight cobalt, 0 to 20% by weight nickel, 5 to 50% by weight chromium, 0.4 to 2.5% by weight carbon and at least one carbide-forming metal which forms carbides with the carbon, wherein the atomic ratio in the alloy of the carbide-forming metal to the carbon amounts to at least 0.8, wherein the alloy can furthermore optionally contain one or more of the elements molybdenum, tungsten, aluminum, titanium, niobium, iron, silicon, manganese, vanadium, boron, zirconium and contaminants. The carbides are present in the alloy in the form of a finely dispersed phase without a preferred direction.

It has been found that this cobalt alloy has a much higher high-temperature stability, in particular with respect to the carbides. Unlike known cobalt-base alloys which are characterized by a directional solidification in which the carbides are separated in an aligned fibrous structure, the cobalt alloy in accordance with the invention can be called an equiaxial alloy. The individual carbides have no main preferred direction, that is, for example, are not fibrous, but are rather comparable to grains. These carbides are dispersed finely and substantially uniformly over the cobalt matrix, that is the carbides form a finely dispersed phase. A preferred direction, such as exists in the directionally solidified cobalt alloys, does not exist in the cobalt alloys in accordance with the invention.

The components designated as optional and which can be constituents of the cobalt alloy in accordance with the invention are elements which are typically used as additives in super alloys, in particular in cobalt-base alloys.

The carbides are preferably at least predominantly of the MC type. In this particularly stable type, the atomic ratio of metal to carbon in the respective carbide is one to one, that is each carbon atom is linked to precisely one metal atom to form a carbide.

In accordance with the invention, a method is furthermore proposed for manufacturing such a cobalt alloy, wherein the components of the alloy are converted into a melt by heat input and a cooling subsequently takes place with a cooling rate of at least one degree per second, in particular at least ten degrees per second, to produce the finely dispersed carbides. This fast cooling produces the finely dispersed carbide phase.

It has proved essential for the production of the finely dispersed carbide phase without a preferred direction that a cooling of the alloy is realized which is as rapid is possible. It has been shown that at a cooling rate of at least one degree per second, in particular at least ten degrees per second, the desired structure of the carbide phase can be realized, namely the fine dispersal of the carbides and the avoidance of a preferred direction such as is present in the directionally solidified alloys.

Further advantageous measures and embodiments of the invention result from the dependent claims.

The invention will be explained in more detail in the following with reference to an embodiment and to the drawing. There is shown in the only drawing FIGURE:

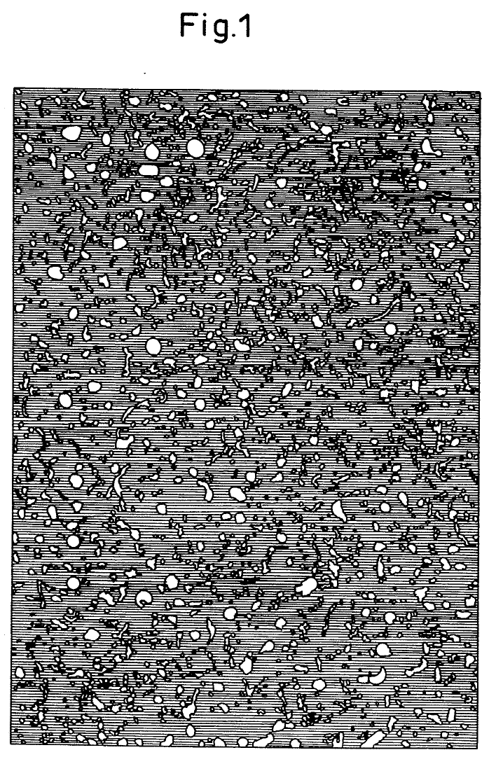

FIG. 1: an enlarged view of a layer of an embodiment of an alloy in accordance with the invention.

A cobalt alloy is proposed by the invention which contains carbides and which is in particular characterized in that the carbides are present in the form of a finely dispersed phase without a preferred direction. It is meant by this that the carbides do not—as is the case in the directionally solidified cobalt alloys—form respective fibers which are aligned along a preferred direction, but the individual carbides are rather made like grains, their separation takes place equiaxially and they are finely dispersed over the cobalt matrix.

It is preferred in this respect that mainly particularly stable carbides of the MC type are formed, that is the atomic ratio of metal M to the carbon C in the carbide is one to one.

To realize this finely dispersed carbide phase in the cobalt matrix, a fast cooling of the alloy is realized.

The alloy in accordance with the invention is made up, apart from contaminants, of at least 30% by weight cobalt (Co) which serves as a base material and compensating material of the alloy, zero to 20% by weight nickel (Ni), 5 to 30% by weight chromium (Cr), 0.4 to 2.5% by weight carbon (C) and at least one carbide-forming metal which forms carbides with the carbon. The atomic ratio of the carbide-forming metal or carbide-forming metals M and the carbon C amounts to at least 0.8, that is of the atomic ratio at least 0.8 metal atoms of M are present per carbon atom C. It is hereby inter alia ensured that predominantly carbides of the MC type are separated. Optionally, the alloy can furthermore contain one or more of the following elements which are usually used in cobalt-base alloys: molybdenum, tungsten, aluminum, titanium, niobium, iron, silicon, manganese, vanadium, boron, zirconium and contaminants.

To achieve a dispersal of the carbides over the cobalt matrix which is as fine as possible, it is preferred that at least the predominant part of the carbides is respectively smaller than 5 micrometers, preferably smaller than or approximately equal to one micrometer.

A few metals are suitable as carbide-forming metals. The carbide-forming metal preferably includes a metal from the group made up of tantalum (Ta), hafnium (Hf), zirconium (Zr) and niobium (Nb). Tantalum is particularly preferred in this respect. The fact that some elements such as zirconium or niobium are named both as carbide formers and as optional components of the alloy is to be understood such that these elements include a first part which serves as a carbide former and a second part which does not form any carbides, but can rather satisfy a different function in the alloy.

It has proved successful in practice if 5 to 30% by weight tantalum is contained as the carbide forming metal, with the tantalum being able to be replaced entirely or partially and, for instance, in an atomic ratio of one to one, by hafnium and/or zirconium. “In an atomic ratio of one to one” in this respect means that a number of tantalum atoms can be replaced by an equal number of hafnium atoms or an equal number of zirconium atoms or an equal number of a mixture of hafnium atoms and zirconium atoms.

In the method in accordance with the invention for manufacturing the cobalt alloy in accordance with the invention, the components of the alloy are converted into a melt by heat input and a fast cooling with a cooling rate of at least one degree per second, in particular at least ten degrees per second, subsequently takes place for producing the finely dispersed carbides.

In accordance with a preferred method, the heat input takes place by laser welding because the required cooling rate can be realized relatively easily in this process.

The cobalt alloy in accordance with the invention and the method in accordance with the invention can in particular be used for welding or coating, in particular by means of laser welding.

### Example

The starting material for the alloy is provided in the form of a powder mixture. The starting material contains (apart from contaminants) 10% by weight nickel, 20% by weight chromium, 20% by weight tantalum, 1.2% by weight carbon. The remainder is cobalt. The tantalum can be replaced totally or partially and approximately in the atomic ratio one to one by hafnium and/or zirconium. This powder is now applied to a substrate in a laser welding process known per se. A molten bath is produced locally on the substrate into which the powder is introduced. On the subsequent cooling, which takes place at least one degree per second, the cobalt alloy in accordance with the invention is then formed with the finely dispersed carbide phase. The powder here therefore serves as a weld filler in a laser welding process.

FIG. 1 shows an enlarged view of a layer from the embodiment of an alloy in accordance with the invention. The lighter spots or dots form the carbide phase which is embedded in the black or darker matrix in accordance with the illustration. It can clearly be recognized that the individual carbides are made like grains, their separation takes place equiaxially, that is without a preferred direction, and they are finely and uniformly dispersed over the cobalt matrix. The predominant part of the carbides has an extent which is smaller than or approximately equal to one micrometer. To demonstrate that the carbides are also in particular stable at high temperatures, the alloy shown in FIG. 1 was maintained at 1000° C. for a thousand hours. FIG. 1 shows the cobalt alloy after this annealing.

The cobalt alloy in accordance with the invention is suitable both as a welding material, for example for the production of weld seams, or for the repair of workpieces or for build-up welding, for example for the manufacture of components, and as a coating material, for example to apply a protective layer against (hot) corrosion or wear to a substrate.

The cobalt alloy in accordance with the invention or the method in accordance with the invention are in particular suitable for the manufacture or for the repair of parts of a gas turbine, in particular for the manufacture and for the repair of turbine vanes.

1. A cobalt alloy made up of at least 30% by weight cobalt, 0 to 20% by weight nickel, 5 to 30% by weight chromium, 0.4 to 2.5% by weight carbon and at least one carbide-forming metal which forms carbides with the carbon, wherein the atomic ratio in the alloy of the carbide-forming metal to the carbon amounts to at least 0.8, wherein the alloy can furthermore optionally contain one or more of the elements molybdenum, tungsten, aluminum, titanium, niobium, iron, silicon, manganese, vanadium, boron, zirconium and contaminants, characterized in that the carbides are present in the alloy in the form of a finely dispersed phase without a preferred direction.

2. A cobalt alloy in accordance with claim 1, wherein the carbides are predominantly of the MC type.

3. A cobalt alloy in accordance with claim 1, wherein at least the predominant part of the carbides is in each case smaller than five micrometers, preferably smaller than or approximately equal to one micrometer.

4. A cobalt alloy in accordance with claim 1, wherein the carbide forming metal includes at least one metal from the group made up of tantalum, hafnium, zirconium and niobium.

5. A cobalt alloy in accordance with claim 1, wherein 5 to 30% by weight tantalum is contained as the carbide forming metal, with the tantalum being able to be replaced entirely or partially and approximately in an atomic ratio of one to one by hafnium and/or zirconium.

6. A cobalt alloy in accordance with claim 1 having 10% by weight nickel, 20% by weight chromium, 20% by weight tantalum, 1.2% by weight carbon and the remainder cobalt, wherein the tantalum can be replaced entirely or partially and approximately in an atomic ratio of one to one by hafnium and/or zirconium.

7. A method for manufacturing a cobalt alloy in accordance with claim 1, wherein the components of the alloy are converted into a melt by heat input and a cooling subsequently takes place with a cooling rate of at least one degree per second, in particular at least ten degrees per second, to produce the finely dispersed carbides.

8. A method in accordance with claim 6, wherein the heat input takes place by laser welding.

9. Use of a cobalt alloy in accordance with a method in accordance claim 7 for welding or coating, in particular by means of laser welding.

10. Use of a cobalt alloy in accordance with a method in accordance with claim 7 for manufacturing or for repairing parts of a gas turbine, in particular of turbine vanes.
